(19) United States
(12) Patent Application Publication
(10) Pub. No.: US 2003/0058658 A1
(43) Pub. Date: Mar. 27, 2003

(54) LED light bulb with latching base structure

(76) Inventor: Han-Ming Lee, Taipei City (TW)

Correspondence Address: LEE, HAN-MING, P.O. BOX 7-820, TAIPEI CITY, TW

(21) Appl. No.: 09/962,294

(22) Filed: Sep. 26, 2001

(51) Int. Cl. F21V 21/08

(52) U.S. Cl. 362/555; 362/396; 362/800; 313/318.05; 439/375; 439/616

(57) ABSTRACT

The present invention relates to a LED light bulb with latching base structure mainly characterized in that both lateral sides of the terminal plate have an inwardly angled conical surface, and the plate has a groove being diagonally cut from the center to facilitate the terminal plate to be smoothly slid into a plugged-in base in the corresponding inwardly-angled direction. At the same time, the plate by means of the space of the diagonally cut groove to enable the sprung-back latch onto the base track by the squeezing motion to the conical surface on both lateral sides, and the two leg pillars of the light bulb have a latching member, and the body of the latching member has an inverted angled surface such that the inverted angled surface corresponding to both tracks of the light base is aligned at the groove and pressed and embedded in the same direction, and the latching member is integrally secured into the inverted latching base. The protruded member between two wings of the base plug is coupled to the two lateral holes on the light base such that the base is plugged to fix the terminal wire from being moved back and forth or being fallen apart. Such arrangement provides a secure integrally latched the LED light bulb assembly for the light base.

### BACKGROUND OF THE INVENTION

Christmas decorative lights are assembled in a series, and the traditional light bulbs are installed in a series onto the light sockets. Traditional light bulb relies on the laborious process for the core pillar, tungsten, glass sealed opening, and gas discharge, and the filament of the light bulb must use a light bud to be inserted onto the light socket. Since the process is labor intensive, and requires several transportation operations, and most importantly it requires all kinds of technologies, it is time consuming or even inconvenient and not easy to accomplish. Since the structure of LED does not need complicated components that may cause defectives during the manufacturing process, and more particularly it does not have the limitations for the tungsten which limits the life and light effect, but it can be used repeatedly for long time, with even brightness and reliable quality. It definitely is a good substitution for the tungsten in the e-generation having the function for environment protection. Therefore, its application on the decorative lights is the trend. However, the LED structure is completely unlike that of the traditional light bulb, therefore the LED coupled with the light base will have different properties, and that is an application related to the LED coupling to the light base according to the present invention.

### SUMMARY OF THE INVENTION

The main object of this invention is to provide a LED light bulb with latching base structure, more particularly one with the assembly of components including a LED light, a terminal plate, a base plug, and a light socket provides a secure integrally LED light bulb assembly with latching base structure.

The secondary objective of this invention is to provide a LED light bulb with latching base structure, more particularly one having an inwardly-angled conical surface on both sides of the terminal plate, and said conical plate has a groove diagonally cut from the center towards the outside end that allows the relative inward angle to be slid smoothly and embedded into the socket, while a compressed movement space with the disappearing terminal plates on both sides of the conical shape makes the latching member bounce back and fix it into the base track.

Another objective of this invention is to provide a LED light bulb with latching base structure, more particularly one having a LED light with a latching member each on the end of two leg pillars of the light bulb, and the latching member each having an inverted-angled surface stridden across two tracks on the light base corresponding to a groove, so that the inverted-angled surface is pushed in the same direction and embedded to let the latching member be hung inversely in order to secure the latching base in position.

It is still another objective of this invention is to provide a LED light bulb with latching base structure, more particularly one having a base plug, which is a lump of the mutually embedded groove for the light base, and two winged protruded members being coupled to both sides of the base plug in order to fix the terminal wire into position and prevent it from moving forward or backward, thereby it will not shake or fall off.

### BRIEF DESCRIPTION OF THE DRAWINGS

FIG. 1 is shows the assembled structure of the present invention;

FIG. 2 is shows the parts of the structure of the present invention;

FIG. 3 is shows the assembled structure of a preferred embodiment of the present invention;

FIG. 4 is shows the assembled structure of another preferred embodiment of the present invention;

FIG. 5 is shows the schematic diagram of the cross-section of the assembled structure of the present invention;

FIG. 6 is shows the clear diagram of the cross-section of the assembled structure of the present invention.

### DELTAILED DESCRIPTION OF THE PREFERRED EMBODIMENT

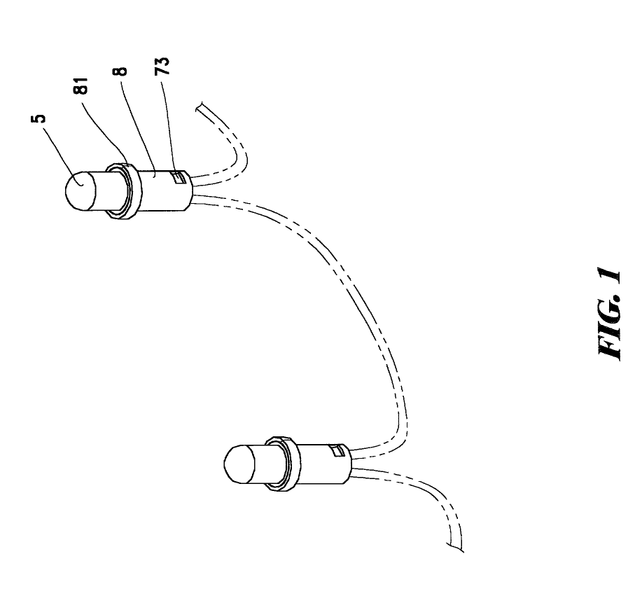

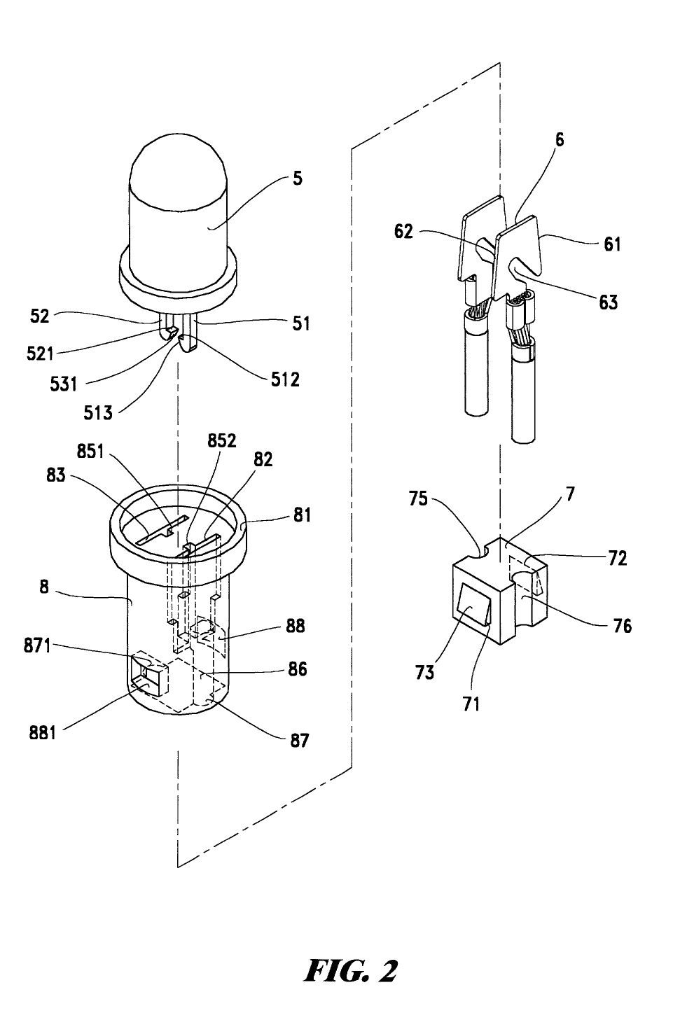

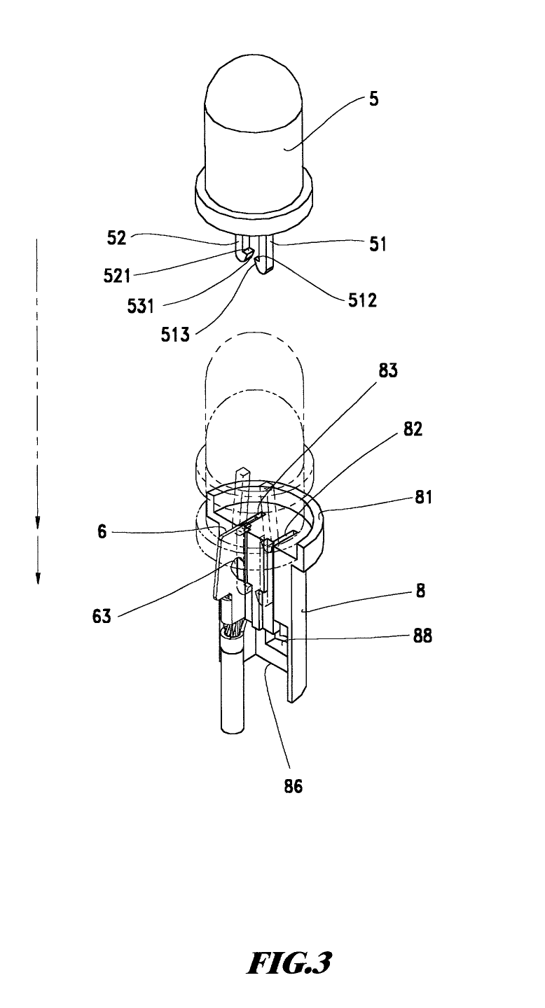

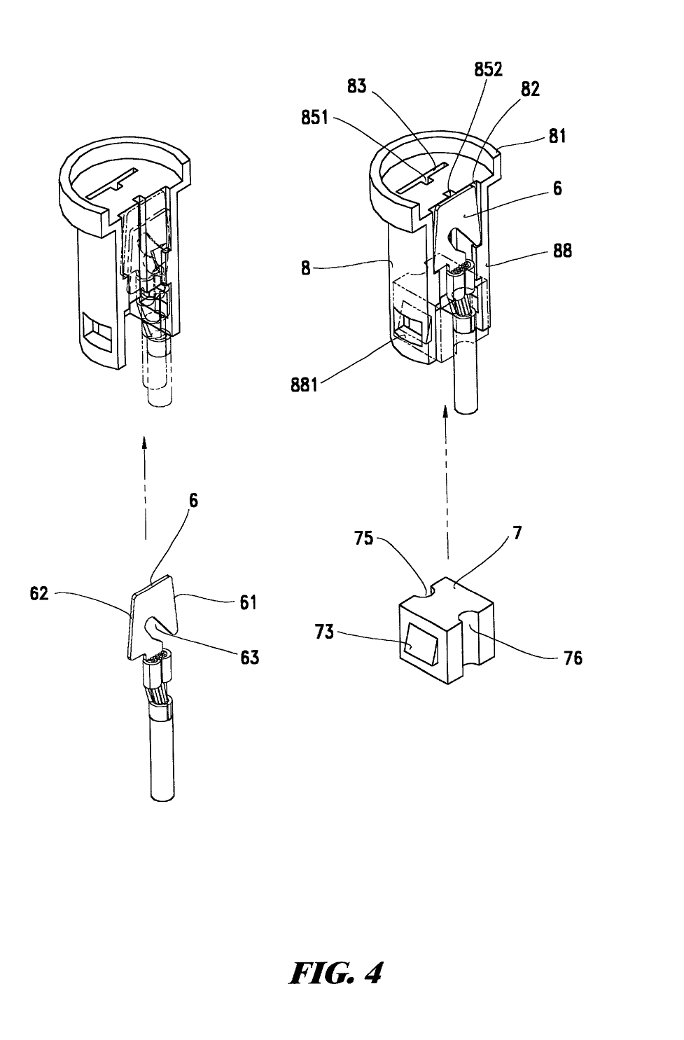

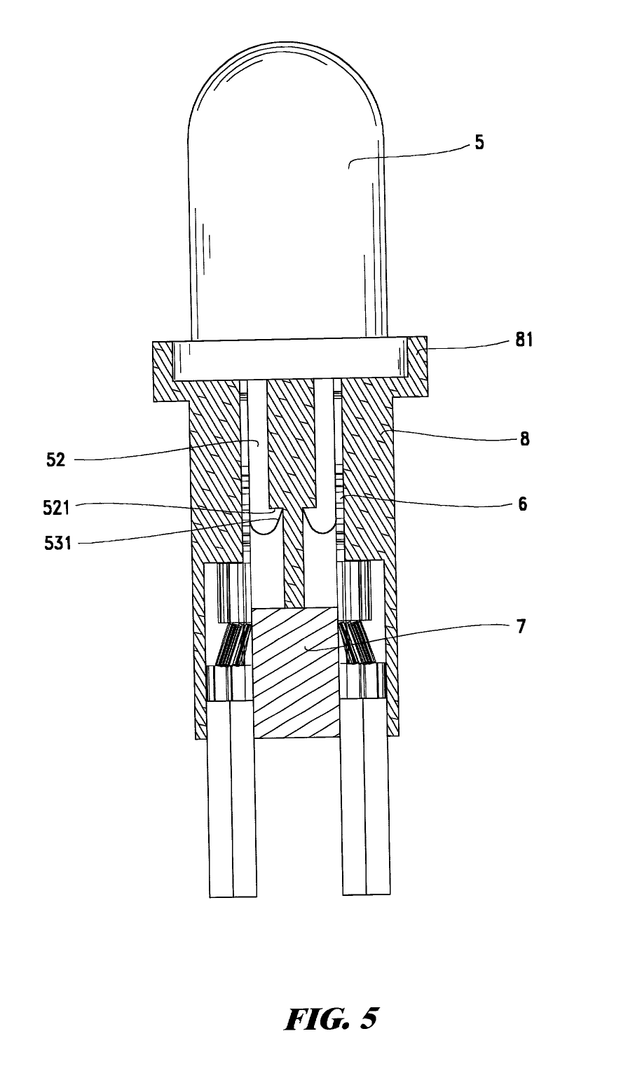

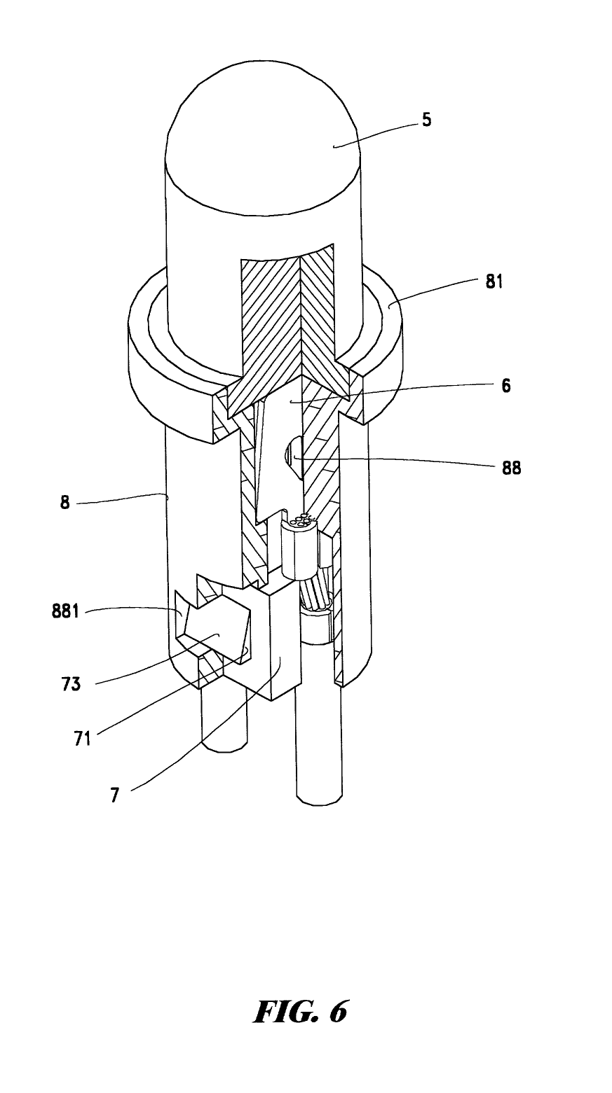

With reference to the drawings and in particular to FIG. 1 through 6. The LED light bulb with latching base structure of the present invention comprises the components of a LED light, a terminal plate, a base plug, and a light base, mainly characterized in that the LED lamp has a light bulb 5 with two leg pillars 51, 52, each having a latching member 512, 521 coupled to its end, and the lower edge of the latching member has a paired inverted-angled surfaces 513, 531 to facilitate the insertion of the two tracks of the light base into the groove passage, and the terminal plate is a plate 6 having wrapped wire at the lower end, and both sides of the upper end of the terminal plate has an inwardly-angled conical surface 61, 62. The conical plate is cut diagonally from the center towards the external edge such that a groove 63 is exposed and tampered terminal plate having a compress motion space on both sides of the upper section of the conical shape. The plug base is a lump 7 of the mutually embedded groove for the light base, and two winged protruded members 71, 72 being coupled to both sides of the base plug, and the protruded lump has a reverse passage 73 to facilitate the reverse pushing for latching assembly, and the lump has a pair of depressed radius tracks 75, 76 corresponding to the radius groove embedded into the groove wall of the light base to form a circular track. The light base is coupled to the circular base 8, and the frame perimeter 81 forms a chamber for coupling the light bulb, and the surface of the base is cut to form a groove track 82, 83 in the partition section leading to the lower section of the circular base, and the groove track extends a tampered narrow passage within a distance, and the groove is disposed between two groove tracks 851, 852 for accommodating the insertion of the light bulb to its lower section, and the paired groove chambers 86 of the base plug expose at the lower edge of the light base, and the groove chamber has two oppositely depressed radius grooves 87, 871, and the groove chambers are aligned to the holes 88, 881 such that the protruding members of the base plug latch together.

In summation of the above description, the structure, function, and operation of the present invention base on the terminal plate with wrapped wire being inserted and embedded into the lower section of the light base, and use an inwardly-angled smooth slope to gently push the plug into the socket, while the plate has a diagonally cut space of the groove for the conical surface on both side to produce a compressed movement and enables the bounced back latch to fix the base track into position and plugs the base plug into the groove chamber corresponding to the lower section of the light base. The reverse-direction passage surface of the protruded lumps on both side of the lump can be pushed smoothly into the two square openings on the light base and latch them in opposite direction such that the two radius tracks corresponding to the radius groove of the groove chamber forms a circle and fix the terminal plate with wrapped wires and makes it uneasy to fall off in order to facilitate the insertion of the paired inverted-angled striding base surface between the wall tracks of the two leg pillars of the LED light into the groove tracks, and the latching member is inversely hung and latches the base in reverse direction in order to attain the effect of securing the LED light bulb with the latching structure as an integral structure.

I claim:

1. A type of LED light bulb with latching base structure, comprising a LED light, a terminal plate, a base plug, and a light base, mainly characterized in that:
LED light, having a latching member each on the end of two leg pillars of the light bulb, and the latching member each having an inverted-angled surface stridden across two tracks on the light base corresponding to a groove;
terminal plate, having a inwardly-angled conical surface disposed on both lateral sides of the terminal plate, and the conical plate having a groove diagonally cut from the center towards the outside end that forms a compressed movement space with the disappearing terminal plates on both sides of the conical shape;
base plug, being a lump of the mutually embedded groove for the light base, and two winged protruded members being coupled to both sides of the base plug, and the protruded lump has a reverse passage to facilitate the reverse pushing for latching assembly, and the lump has a pair of depressed radius tracks corresponding to the radius groove embedded into the groove wall of the light base to form a circular track;
light base, being coupled to the circular base, and the frame perimeter forms a chamber for coupling the light bulb, and the surface of the base is cut to form a groove track in the partition section leading to the lower section of the circular base, and the groove track extends a tampered narrow passage within a distance, and the groove is disposed between two groove tracks for accommodating the insertion of the light bulb to its lower section, and the paired groove chambers of the base plug expose at the lower edge of the light base, and the groove chamber has two oppositely depressed radius groove, and the groove chambers are aligned to the hole such that the protruding members of the base plug latch together;
by means of the assembly of the above elements, it forms an integral latching structure for a LED light bulb assembled light base.

2. A type of LED light bulb with latching base structure as claimed in claim 1, wherein said terminal plate having an inwardly-angled smooth slope for gently pushing the plug into the socket, while the plate having a diagonally cut space of the groove for the conical surface on both side to produce a compressed movement and enable the bounced back latch to fix the base track into position.

3. A type of LED light bulb with latching base structure as claimed in claim 1, wherein said light bulb having the latching member on two leg pillars with a paired inverted-angled surfaces corresponding to two tracks of the light base and having a groove track for pressing and embedding in the same direction such that the latching member inversely hangs to secure the latching base as an integral assembly.
